(19) United States
(12) Patent Application Publication
(10) Pub. No.: US 2023/0402928 A1
(43) Pub. Date: Dec. 14, 2023

(54) POWER CONTROL SYSTEM WITH ZERO VOLTAGE SWITCHING

(71) Applicant: INNO-TECH CO., LTD., Taipei City (TW)

(72) Inventors: Shu-Chia Lin, Taipei City (TW); Tsu-Huai Chan, Taipei City (TW); Chih-Feng Lin, Taipei City (TW)

(21) Appl. No.: 17/835,963

(22) Filed: Jun. 9, 2022

(51) Int. Cl. H02M 3/335; H02M 1/00; H02M 1/08

(52) U.S. Cl. CPC H02M 3/33569; H02M 1/0058; H02M 1/08; H02M 1/0009

(57) ABSTRACT

Disclosed is a power control system with zero voltage switching including a power controller, a rectification unit, a power unit, a transformer unit, a primary side switch unit, a current sensing unit, an auxiliary switch unit, an output unit, and a current sensing unit for implementing a function of flyback power conversion. The power controller has a power pin, a ground pin, a primary side driving pin, a voltage sensing pin, an auxiliary driving pin, and an auxiliary winding sensing pin, In particular, the auxiliary switch unit is controlled to influence an primary side winding through an auxiliary winding so as to reduce the drain voltage of the primary side switch unit. Further, the primary side switch unit is turned on when the drain voltage is decreased to the lowest value, thereby greatly reducing switching loss and increasing efficiency of power conversion.

### BACKGROUND OF THE INVENTION

### 1. Field of the Invention

The present invention generally relates to a power control system, and more specifically to a power control system with zero voltage switching employing the auxiliary switch unit connected to the auxiliary winding, and utilizing the power controller to generate the auxiliary driving signal to control the auxiliary switch unit to turn on or off, thereby influencing the primary side winding, and reducing the drain voltage of the primary side switch unit such that the primary side driving signal generated by the power controller is specifically intended to turn on the primary side switch unit when the drain voltage of the primary side switch unit is the lowest voltage or approximate to zero voltage so as top greatly reduce switch loss and increase efficiency of power conversion.

### 2. The Prior Arts

As electronic technology and the semiconductor processes have make great progress, many manufactures of end products have developed various electronic devices with highly integrated functions, which usually need different high quality power to operate. For example, integrated circuits (ICs) usually operate at 1.2V, electric motors feeds 12V, and inverters of the backlight module require more than 100V. Thus, high efficiency power converters are needed to build specific power supplies to generate high quality power as desired.

As well known, the switching power supply employing the scheme of pulse width modulation (PWM) is one of the most widely used power supply in the prior arts because of its smaller physical size and higher efficiency of conversion than other traditional linear power supplies for the same output power. For a flyback power converter as an example of the switching power supply, a power controller in collocation with a transformer formed of a primary side winding and a secondary side winding, a switch unit, a current sensing resistor, an output rectifier, and an output capacitor. The primary side winding of the transformer, the switch unit, and the current sensing resistor configure a primary side loop, and the secondary side winding of the transformer, the output rectifier, and the output capacitor configure a secondary side loop. In particular, the power controller generates a PWM driving signal to drive the switch unit like power transistor, and the PWM driving signal periodically turns on and off the switch unit to further conduct and cut off the current flowing through the switch unit. As a result, the input power is converted into the output power through electro-magnetization between and a winding ratio of the primary side winding and the secondary side winding, and the output power supplies a load for operation. That is, a function of power conversion is implemented.

In addition, the primary side winding substantially has magnetizing inductance and leakage inductance. Leakage inductance results from magnetic flux in the primary side fails to couple the secondary side winding, and energy stored in leakage inductance is dissipated by other electric element. Thus, leakage inductance is the root cause for a considerable highly voltage as so called voltage spike at the drain of the switch unit occurring while the switch unit is just turned off.

Further, when the switch unit is turned on, the primary side current flows through the primary side winding for storing energy in the primary side winding. When the switch unit is turned off, LC resonance is induced between the drain-source of the switch unit and the parasite capacitor because energy stored in leakage inductance fails to couple the secondary side winding, resulting in voltage spike at the drain-source of the switch unit. After LC resonance, the voltage across the drain-source of the switch unit gradually decreases from a spike value to a fixed voltage called knee, indicating that energy stored in leakage inductance is completely dissipated. At this moment, the secondary side current is zero, and the secondary side loop is open. The primary side loop forms a RLC resonance tank to generate damping oscillation with an oscillation frequency, and a valley when the drain voltage of the switch unit becomes the lowest value is predictable based on the oscillation frequency.

Additionally, when the switch unit is fast and periodically turned on and off, switch loss occurs because some electrical signals like current and voltage are not continuous, and overall power conversion efficiency thus decreases. For example, if the switch unit is turned on when the drain voltage of the switch unit is the lowest like so-called valley voltage, switch loss is greatly suppressed. In the prior arts, the turn on time for the switch unit is usually selected at the moment when the voltage across the drain-source of the switch unit is the lowest value. This scheme is often called quasi-resonance (QR) switching or valley switching. The reason is that energy loss is less, and switch loss is thus reduced.

Usually, QR switching or valley switching is implementing by estimating when knee occurs in advance, then further calculating the time of valley based on the oscillation frequency of damping oscillation, and selecting which valley to turn on the switch unit like the third valley. While switch loss is reduced by the above scheme, each electrical element built in the power converter affects the time of knee and the frequency of damping oscillation. Therefore, it needs to adjust or calculate the time of knee and the frequency of damping oscillation to match the current circuit, or it fails to turn on the switch unit right at valley. In addition, when the loading is lighter, it is better to turn on the switch unit later, but when the loading is heavier, the switch unit needs to turn on earlier.

Obviously, the turn on time for the switch unit has to be re-adjusted or re-calculated if any electrical element is changed, and it is not convenient to implement for actual applications. In other words, one shortcoming in the prior arts is that the optimal turn on time for another loading level and different actual electric environment is not the same such that the power controller fails to predict and dynamically adjust or set the corresponding turn on time. Overall, most applications are not well satisfied.

Therefore, it is greatly needed to provide a new power control system employing the auxiliary switch unit connected to the auxiliary winding, and utilizing the power controller to generate the auxiliary driving signal to control the auxiliary switch unit to turn on or off so as to influence the primary side winding, and reduce the drain voltage of the primary side switch unit such that the primary side driving signal generated by the power controller is able to turn on the primary side switch unit when the drain voltage of the primary side switch unit is the lowest voltage or approximate to zero voltage, thereby greatly reducing switch loss, increasing efficiency of power conversion, and overcoming the above problems in the prior arts.

### SUMMARY OF THE INVENTION

The primary objective of the present invention is to provide a power control system with zero voltage switching comprising a power controller, a rectification unit, a power unit, a transformer unit, a primary side switch unit, an auxiliary switch unit, an output unit, and a current sensing unit for implementing a function of flyback power conversion. The power controller comprises a power pin, a ground pin, a primary side driving pin, a voltage sensing pin, an auxiliary driving pin and an auxiliary winding sensing pin, and the ground pin is connected to a ground level. The primary side switch unit and the auxiliary switch unit comprise a Metal-Oxide-Semiconductor (MOS) transistor, a Gallium Nitride field effect transistor (GaN FET), or a silicon carbide (SiC)-MOSFET.

The rectification unit receives and rectifies an external input power to generate a rectified power, and the rectification unit is electrically connected to the ground level through a rectification auxiliary capacitor. The power unit also receives the external input power to generate and transmit a power voltage to the power pin such that the power controller receives the power voltage to operate.

The transformer unit comprises a primary side winding, an auxiliary winding, and a secondary side winding electromagnetically coupled together, and an end of the primary side winding connected to the rectification unit for receiving the rectified power.

The primary side switch unit comprises a drain connected to the other end of the primary side winding, a gate connected to the primary side driving pin, and a source connected to the voltage sensing pin.

An end of the current sensing unit is connected to the voltage sensing pin, the other end of the current sensing unit is connected to the ground level, and the voltage sensing pin generates a current sensing signal.

The auxiliary switch unit comprises a drain connected to the rectification unit for receiving the rectified power, a gate connected to the auxiliary driving pin, and a source connected to an end of the auxiliary winding and the auxiliary winding sensing pin. Further, the other end of the auxiliary winding is connected to the ground level, and the source of the auxiliary winding generates an auxiliary winding voltage. Specifically, the auxiliary winding voltage corresponding to a drain voltage of the drain of the primary side switch unit.

The drain of the primary side switch unit is further connected to the ground level through an auxiliary capacitor.

An end of the output unit is connected to an end of the secondary side winding for generating an output power to supply a load connected to the output unit, and the other end of the output unit is connected to the ground level. Also, the other end of the secondary side winding is connected to the ground level.

The above power controller executes a zero voltage switching control process to generate a primary side driving signal and an auxiliary driving signal. The primary side driving signal is transmitted to the gate of the primary side switch unit through the primary side driving pin, and the auxiliary driving signal is transmitted to the gate of the auxiliary switch unit through the auxiliary driving pin. The primary side driving signal is substantially a pulse width modulation (PWM) signal having a PWM frequency and provided with a turn on level and a turn off level for periodically turning on and off the primary side switch unit. More specifically, the turn on level is sustained for a turn on time, and the turn off level is sustained for a turn off time. In particular, the PWM frequency is dependent on a loading level of the load, and the turn on time is based on the output power.

More specifically, the zero voltage switching control process generally comprises: detecting and determining whether the auxiliary winding voltage is lower than a knee when the auxiliary switch unit is turned off and then the primary side switch unit is turned off; determining a demagnetization time when the auxiliary winding voltage is lower than the knee, and then calculating a turn on delay time, the demagnetization time referring to a period from the time when the primary side switch unit is turned off to the time when the auxiliary winding voltage is lower than the knee; driving the auxiliary driving signal to turn on the auxiliary switch unit after the turn on delay time, and then setting, changing, or calculating an auxiliary turn on time; after the auxiliary turn on time, driving the auxiliary driving signal to turn off the auxiliary switch unit, and then calculating a separate time; and driving the primary side driving signal to turn on the primary side switch unit after the separate time, the turn off time substantially comprising the demagnetization time, the turn on delay time, the auxiliary turn on time, and the separate time.

Thus, the turn off time substantially comprises the demagnetization time, the turn on delay time, the auxiliary turn on time, and the separate time.

Overall, the present invention employs the auxiliary switch unit connected to the auxiliary winding, and the power controller generates the auxiliary driving signal to control the auxiliary switch unit to turn on or off, thereby influencing the primary side winding, and reducing the drain voltage of the primary side switch unit. As a result, the primary side driving signal generated by the power controller is specifically intended to turn on the primary side switch unit when the drain voltage of the primary side switch unit is the lowest voltage or approximate to zero voltage so as top greatly reduce switch loss and increase efficiency of power conversion.

### BRIEF DESCRIPTION OF THE DRAWINGS

The present invention can be understood in more detail by reading the subsequent detailed description in conjunction with the examples and references made to the accompanying drawings, wherein:

FIG. 1 is a view showing the power control system with zero voltage switching according to the first embodiment of the present invention;

FIG. 2 is a view showing the operation waveform of the power control system according to the first embodiment of the present invention; and

FIG. 3 is a view showing the simplified operation waveform of the power control system according to the first embodiment of the present invention.

### DETAILED DESCRIPTION OF THE PREFERRED EMBODIMENT

The present invention may be embodied in various forms and the details of the preferred embodiments of the present invention will be described in the subsequent content with reference to the accompanying drawings. The drawings (not to scale) show and depict only the preferred embodiments of the invention and shall not be considered as limitations to the scope of the present invention. Modifications of the shape of the present invention shall too be considered to be within the spirit of the present invention.

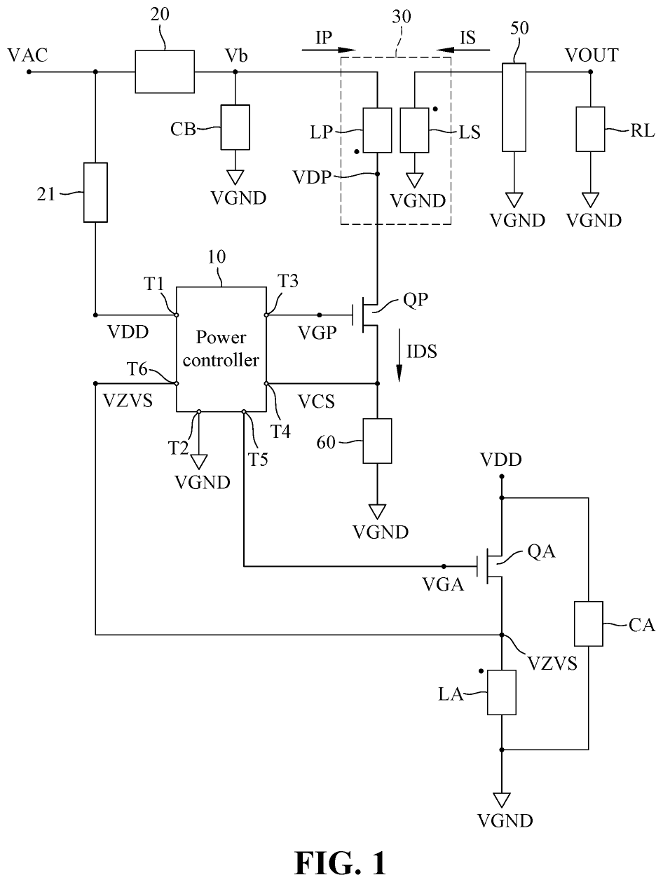

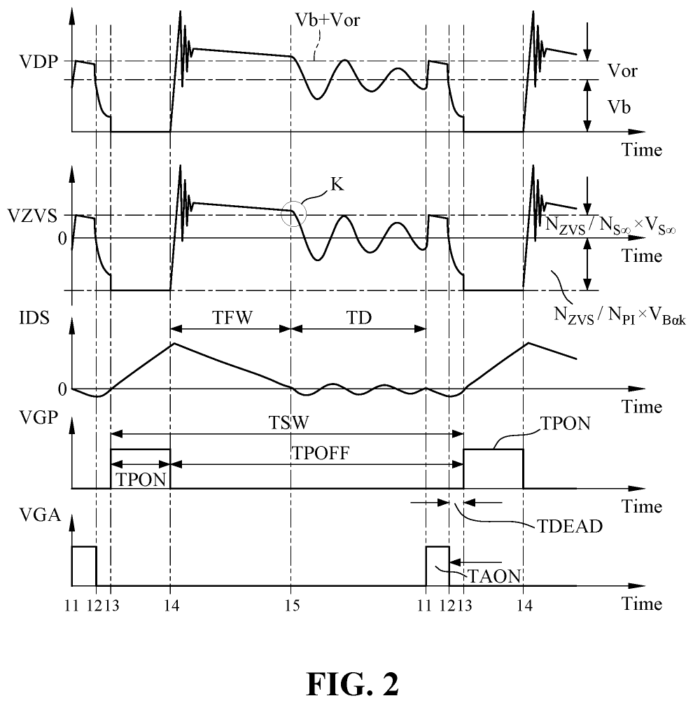

Please refer to FIGS. 1 and 2 illustrating the power control system with zero voltage switching and the operational waveform according to the first embodiment of the present invention. As shown in FIGS. 1 and 2, the power control system with zero voltage switching according to the first embodiment of the present invention comprises a power controller 10, a rectification unit 20, a power unit 21, a transformer unit 30, a primary side switch unit QP, an auxiliary switch unit QA, an output unit 50, and a current sensing unit 60 for implementing a function of flyback power conversion.

Specifically, the power controller 10 comprises a power pin T1, a ground pin T2, a primary side driving pin T3, a voltage sensing pin T4, an auxiliary driving pin T5, and an auxiliary winding sensing pin T6, and the ground pin T2 is connected to a ground level VGND. The transformer unit 30 comprises a primary side winding LP, an auxiliary winding LA, and a secondary side winding LS electromagnetically coupled together. Further, the primary side switch unit QP and the auxiliary switch unit QA comprise a Metal-Oxide-Semiconductor (MOS) transistor, a Gallium Nitride field effect transistor (GaN FET), or a silicon carbide (SiC)-MOSFET.

In addition, the rectification unit 20 receives and rectifies an external input power VAC to generate a rectified power Vb, and the rectification unit 20 is further electrically connected to the ground level VGND through a rectification auxiliary capacitor CB for providing a filtering function for the rectified power Vb. The power unit 21 also receives the external input power VAC to generate and transmit a power voltage VDD to the power pin such that the power controller 10 receives the power voltage VDD to operate.

Further, an end of the primary side winding LP is connected to the rectification unit 20 for receiving the rectified power VIN, the other end of the primary side winding LP is connected to a drain of the primary side switch unit QP, a gate of the primary side switch unit QP is connected to the primary side driving pin T3, and a source of the primary side switch unit QP is connected to the voltage sensing pin T4.

An end of the current sensing unit 60 is connected to the voltage sensing pin T4, the other end of the current sensing unit 60 is connected to the ground level VGND, and the voltage sensing pin T4 generates a current sensing signal VCS.

The auxiliary switch unit QA comprises a drain connected to the rectification unit 20 for receiving the rectified power VIN, a gate connected to the auxiliary driving pin T5, and a source connected to an end of the auxiliary winding LA and the auxiliary winding sensing pin T6. Further, the other end of the auxiliary winding LA is connected to the ground level VGND, and the drain of the auxiliary side switch unit QA is further connected to the ground level VGND through an auxiliary capacitor CA. Also, the source of the auxiliary winding LA generates an auxiliary winding voltage VZVS. Specifically, the auxiliary winding voltage VZVS corresponding to a drain voltage of the drain of the primary side switch unit QP.

An end of the output unit 50 is connected to an end of the secondary side winding LS for generating an output power VOUT to supply a load RL connected to the output unit 50, and the other end of the output unit 50 is connected to the ground level VGND. Also, the other end of the secondary side winding LS is connected to the ground level VGND.

More specifically, the power controller 10 executes a zero voltage switching control process to generate a primary side driving signal VGP and an auxiliary driving signal VGA. The primary side driving signal VGP is transmitted to the gate of the primary side switch unit QP through the primary side driving pin T3, and the auxiliary driving signal VGA is transmitted to the gate of the auxiliary switch unit QA through the auxiliary driving pin T5.

The above primary side driving signal VGP is substantially a pulse width modulation (PWM) signal having a PWM frequency or a PWM period TSW, and provided with a turn on level and a turn off level for periodically turning on and off the primary side switch unit QP. More specifically, the turn on level is sustained for a turn on time TPON, and the turn off level is sustained for a turn off time TPOFF. In particular, the PWM frequency or the PWM period TSW is dependent on a loading level of the load RL, and the turn on time TPON is based on the output power VOUT. Since the scheme for appropriately selecting the PWM frequency and the turn on time TPON is commonly used in the prior arts, the related description is omitted hereinafter.

Moreover, the zero voltage switching control process generally comprises the following operational steps. However, it should be noted that the auxiliary winding voltage VZVS substantially corresponds to the drain voltage VDP of the primary side switch unit QP, and the process employing the auxiliary winding voltage VZVS is thus intended for the drain voltage VDP of the primary side switch unit QP.

First, when the auxiliary switch unit QA is turned off and then the primary side switch unit QP is turned off, It is detected and determined whether the auxiliary winding voltage VZVS is lower than a knee K. Specifically, the knee K refers to a voltage of a turning point where the auxiliary winding voltage VZVS abruptly decreases along a much steeper declining line after a previous less steeper declining line. In other words, the auxiliary winding voltage VZVS decreases more slowly before the knee K and more quicker after the knee K. In general, the turning point as the knee K means the transformer unit 30 completes demagnetization. Since the knee K can be easily detected by comparing the declining slope of the auxiliary winding voltage VZVS with a preset declining slope, and such as scheme is commonly used in the prior arts, the related description is omitted hereinafter.

Then, a demagnetization time TFW is determined when the auxiliary winding voltage VZVS is lower than the knee K. Specifically, the demagnetization time TFW refers to a period from the time when the primary side switch unit QP is turned off to the time when the auxiliary winding voltage VZVS is lower than the knee K. the whole of the demagnetization time TFW for the auxiliary winding voltage VZVS is usually called a free-wheeling phase. After the free-wheeling phase, the auxiliary winding voltage VZVS enters a phase of a damping oscillation or simply called oscillation phase. Subsequently, a turn on delay time TD is calculated or set. After the turn on delay time TD, the auxiliary driving signal VGA is generated and driven to turn on the auxiliary switch unit, QA, and then an auxiliary turn on time TAON is generated by setting, changing, or calculation.

After the auxiliary turn on time TAON, the auxiliary driving signal VGA is generated and driven to turn off the auxiliary switch unit QA, and a separate time TDEAD is then calculated. It is preferred that the separate time TDEAD is preset within 150 ns and 250 ns. After the separate time TDEAD, the primary side driving signal VGP is generated and driven to turn on the primary side switch unit QP. In other words, the primary side switch unit QP and the auxiliary switch unit QA are not turned on at the same time, and particularly separated by the separate time TDEAD. Subsequently, the primary side switch unit QP is turned off after the turn on state sustained for the turn on time TPON, thereby completing the periodical operation for the primary side driving signal VGP and the auxiliary driving signal VGA.

Overall, the above turn off time TPOFF substantially comprises the demagnetization time TFW, the turn on delay time TD, the auxiliary turn on time TAON, and. the separate time TDEAD, and the auxiliary switch unit QA is turned on after the primary side switch unit QP is turned off and the turn off state of the primary side switch unit QP is sustained for a period of the demagnetization time TFW and the turn on delay time TD. In particular, the turn on state of the auxiliary switch unit QA is sustained for a period of the auxiliary turn on time TAON, and then the auxiliary switch unit QA is turned off. Subsequently, the primary side switch unit QP is turned on after a period of the separate time TDEAD.

Further, the primary feature of the auxiliary driving signal VGA is to reduce the drain voltage of the primary side switch unit QP. That is, when the primary side switch unit QP is turned on, the drain voltage of the primary side switch unit QP is greatly reduced, even close to zero voltage, as shown in FIG. 2, thereby decreasing switch loss and increasing efficiency of power conversion. It is obvious that the more the auxiliary turn on time TAON, the lower the drain voltage of the primary side switch unit QP. However, if the auxiliary turn on time TAON is too long, the separate time TDEAD becomes too short, and it is not assured that the primary side switch unit QP and the auxiliary switch unit QA are not turned on at the same time. Therefore, it is preferred that the separate time TDEAD is within 150 ns and 250 ns and the auxiliary turn on time TAON is a maximum such that the drain voltage of the primary side switch unit QP is a minimum.

Thus, the auxiliary turn on time TAON is optimally set, modulated, or calculated according to the actual application, and the method of the present invention is practically useful. Certainly, in comparison with the conventional flyback converter, the present invention additionally employs the auxiliary driving signal VGA, and the power consumption is slightly increased, but the increment of the power consumption caused by the auxiliary driving signal VGA is far less than the decrement in of switch loss from practical measurement.

As mentioned above, the auxiliary turn on time TAON can be set, modulated, or calculated, and more specifically the auxiliary turn on time TAON is generated by means of an adjustable setting process, an adaptive modulation process, or a calculating process. The three processes are described in detail as below.

For the adjustable setting process, the voltage of the external input power VAC and the loading level of the load RL are employed to set the auxiliary turn on time TAON. For example, the voltage of the external input power VAC includes 90, 115, and 230 Vac, and the loading level includes ultra light loading, light loading, middle loading, and full loading. As the voltage of the external input power VAC becomes larger, the auxiliary turn on time TAON is prolonged, and as the loading level becomes heavier, the auxiliary turn on time TAON is set shorter.

Or alternatively, the adjustable setting process sets the auxiliary turn on time TAON as an initial turn on time when the voltage of the external input power VAC is 90 Vac, and then modulates or updates the auxiliary turn on time TAON by means of proportional scaling up with respect to the voltage of the external input power when the voltage of the external input power VAC is 115, or 230 Vac. In other words, the auxiliary turn on time TAON is set as proportional to the voltage of the external input power VAC.

In addition, the adaptive modulation process is performed by determining whether the auxiliary winding voltage VZVS is lower than a threshold voltage or not. If the auxiliary winding voltage VZVS is not lower than the threshold voltage, the auxiliary turn on time TAON is periodically updated and set by means of cycle by cycle until the auxiliary winding voltage VZVS is lower than the threshold voltage. Since the auxiliary winding voltage VZVS decreases as the auxiliary turn on time TAON increases, it is more practical to employ the auxiliary turn on time TAON set by a shorter value, and then gradually increase the auxiliary turn on time TAON to force the auxiliary winding voltage VZVS to become lower than the threshold voltage so as to turn on the primary side switch unit QP.

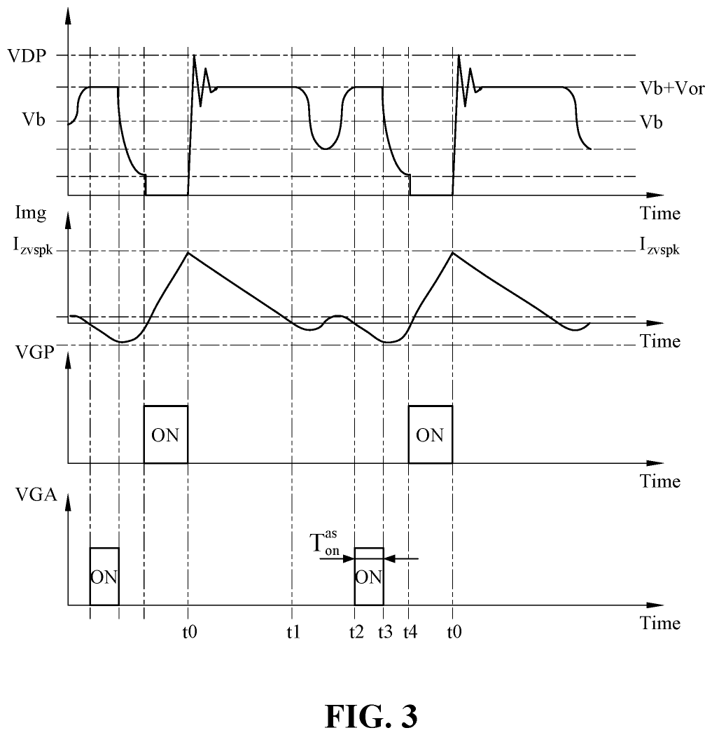

Further refer to FIG. 3 illustrating the simplified operation waveform of the power control system of the present invention. FIG. 3 is similar to FIG. 2, but is appropriately simplified to focus on the period of the damping oscillation to more clearly explain the feature accomplished by the present invention. For the above calculating process, the auxiliary turn on time TAON is generated by a formula specified by:

$${T}_{on}^{as} = \frac{1 + \frac{{V}_{b}}{{V}_{or}}}{2 \times π} \times {T}_{r} ,$$

where Tₒₙ^{as} is the auxiliary turn on time, V_{b} is the rectified power, Vₒᵣ is a maximum amplitude voltage of the drain voltage of the primary side switch unit during the damping oscillation, and Tᵣ is a period of the damping oscillation. The above calculation is deducted substantially based on principle of energy conservation, and comprises:

$$\{ \begin{matrix}\frac{1}{2} \times {L}_{m} \times {I}_{zvspk}^{2} = \frac{1}{2} \times {C}_{oss} \times {( {V}_{b} + {V}_{or} )}^{2} \\ {T}_{r} = 2 \times π \times \sqrt{{L}_{m} \times {C}_{oss}} \\ {L}_{m} \times \frac{{I}_{zvspk}}{{T}_{on}^{as}} = {V}_{or}\end{matrix} ,$$

where Lₘ is the inductance of the primary side winding LP, I_{zvspk} is the peak value of the magnetization current I_{mg} of the transformer 30, and C_{osc} is the parasitic capacitance of the drain of the primary side switch unit QP.

In addition, the auxiliary turn on time can be generated by another calculating process based on an empirical formula specified by: the auxiliary turn on time=(the voltage of the external input power·P1)+P2, where P1 is a first time parameter within and 0.99 ns/V, and P2 is a second time parameter within 31.1 and 31.9 ns. It should be noted that the above formula substantially employs the linear relation between the auxiliary turn on time TAON and the voltage of the external input power VAC so as to reduce the drain voltage of the primary side switch unit QA while turned on, and decrease switch loss.

From the above mention, one aspect of the present invention is that the auxiliary switch unit is connected to the auxiliary winding, and the power controller generates the auxiliary driving signal to turn on or off the auxiliary switch unit. As a result, the auxiliary switch unit is controlled to influence an primary side winding through an auxiliary winding so as to reduce the drain voltage of the primary side switch unit. Further, the primary side switch unit is turned on when the drain voltage is decreased to the lowest value or close to zero voltage, thereby greatly reducing switching loss and increasing efficiency of power conversion.

Further, the flyback converter only provided with valley switching needs to employ the transformer with high winding ratio, or alternatively, uses a QR power controller to turn on the primary side switch unit when the drain voltage of the primary side switch unit decreases below the valley voltage. To implement zero voltage switching (ZVS), ACF or AHB architecture is needed, or more additional windings are required. As a result, overall cost of the system increases, and the system becomes less practical. In contrast, the method of the present invention shares the auxiliary winding LA, or is able to combine a synchronous rectification control for the secondary side to readily match the input voltage, the loading level, or the winding ratio so as to adjust a ZVS control signal and gradually adjust the period of time from the preset value to attain the most appropriate ZVS switch point, thereby improving efficiency of power conversion for the system.

Although the present invention has been described with reference to the preferred embodiments, it will be understood that the invention is not limited to the details described thereof. Various substitutions and modifications have been suggested in the foregoing description, and others will occur to those of ordinary skill in the art. Therefore, all such substitutions and modifications are intended to be embraced within the scope of the invention as defined in the appended claims.

What is claimed is:

1. A power control system with zero voltage switching for implementing a function of flyback power conversion, comprising:
a power controller comprising a power pin, a ground pin, a primary side driving pin, a voltage sensing pin, an auxiliary driving pin and an auxiliary winding sensing pin, the ground pin connected to a ground level;
a rectification unit for receiving and rectifying an external input power to generate a rectified power, the rectification unit electrically connected to the ground level through a rectification auxiliary capacitor;
a power unit for receiving the external input power to generate a power voltage, the power controller receiving the power voltage through the power pin to operate;
a transformer unit comprising a primary side winding, an auxiliary winding, and a secondary side winding electromagnetically coupled together, an end of the primary side winding connected to the rectification unit for receiving the rectified power;
a primary side switch unit comprising a drain connected to the other end of the primary side winding, a gate connected to the primary side driving pin, and a source connected to the voltage sensing pin;
a current sensing unit, an end of the current sensing unit connected to the voltage sensing pin, the other end of the current sensing unit connected to the ground level, the voltage sensing pin generating a current sensing signal;
an auxiliary switch unit comprising a drain connected to the rectification unit for receiving the rectified power, a gate connected to the auxiliary driving pin, and a source connected to an end of the auxiliary winding and the auxiliary winding sensing pin, the other end of the auxiliary winding connected to the ground level, the source of the auxiliary winding generating an auxiliary winding voltage corresponding to a drain voltage of the drain of the primary side switch unit, the drain of the primary side switch unit further connected to the ground level through an auxiliary capacitor; and
an output unit having an end connected to an end of the secondary side winding for generating an output power to supply a load connected to the output unit, and the other end connected to the ground level, the other end of the secondary side winding connected to the ground level,
wherein the power controller executes a zero voltage switching control process to generate a primary side driving signal and an auxiliary driving signal, the primary side driving signal is transmitted to the gate of the primary side switch unit through the primary side driving pin, the auxiliary driving signal is transmitted to the gate of the auxiliary switch unit through the auxiliary driving pin, the primary side driving signal is a pulse width modulation (PWM) signal having a PWM frequency and provided with a turn on level and a turn off level for periodically turning on and off the primary side switch unit, the turn on level is sustained for a turn on time, the turn off level is sustained for a turn off time, the PWM frequency is dependent on a loading level of the load, the turn on time is dependent on a voltage of the output power, and the zero voltage switching control process comprises:
detecting and determining whether the auxiliary winding voltage is lower than a knee when the auxiliary switch unit is turned off and then the primary side switch unit is turned off;
determining a demagnetization time when the auxiliary winding voltage is lower than the knee, and then calculating a turn on delay time, the demagnetization time referring to a period from the time when the primary side switch unit is turned off to the time when the auxiliary winding voltage is lower than the knee;
driving the auxiliary driving signal to turn on the auxiliary switch unit after the turn on delay time, and then setting, changing, or calculating an auxiliary turn on time;
after the auxiliary turn on time, driving the auxiliary driving signal to turn off the auxiliary switch unit, and then calculating a separate time; and
driving the primary side driving signal to turn on the primary side switch unit after the separate time, the turn off time substantially comprising the demagnetization time, the turn on delay time, the auxiliary turn on time, and the separate time.

2. The power control system as claimed in claim 1, wherein the primary side switch unit and the auxiliary switch unit comprise a Metal-Oxide-Semiconductor (MOS) transistor, a Gallium Nitride field effect transistor (GaN FET), or a silicon carbide (SiC)-MOSFET.

3. The power control system as claimed in claim 1, wherein the voltage of the external input power is 90, 115, or 230 Vac, the loading level comprises a ultra light loading, a light loading, a middle loading, and a full loading, the auxiliary turn on time is generated by means of an adjustable setting process, and the adjustable setting process is intended to set the auxiliary turn on time based on the voltage of the external input power and the loading level.

4. The power control system as claimed in claim 3, wherein the voltage of the external input power is 90, 115, or 230 Vac, the loading level comprises a ultra light loading, a light loading, a middle loading, and a full loading, the auxiliary turn on time is generated by means of an adjustable setting process, and the adjustable setting process sets the auxiliary turn on time as an initial turn on time when the voltage of the external input power is 90 Vac, and then updates the auxiliary turn on time by means of proportional scaling up with respect to the voltage of the external input power when the voltage of the external input power is 115, or 230 Vac.

5. The power control system as claimed in claim 1, wherein the auxiliary turn on time is generated by means of an adaptive modulation process, and the adaptive modulation process comprises: determining whether the auxiliary winding voltage is lower than a threshold voltage or not; and when the auxiliary winding voltage is not lower than the threshold voltage; periodically updating and setting the auxiliary turn on time by means of cycle by cycle until the auxiliary winding voltage is lower than the threshold voltage.

6. The power control system as claimed in claim 1, wherein the auxiliary turn on time is generated by a calculating process based on a formula specified by:
$${T}_{on}^{as} = \frac{1 + \frac{{V}_{b}}{{V}_{or}}}{2 \times π} \times {T}_{r} ,$$
Tₒₙ^{as} is the auxiliary turn on time, V_{b} is the rectified power, Vₒᵣ is a maximum amplitude voltage of the drain voltage of the primary side switch unit during the damping oscillation, and Tᵣ is a period of the damping oscillation.

7. The power control system as claimed in claim 1, wherein the auxiliary turn on time is generated by a calculating process based on a formula specified by: the auxiliary turn on time=(the voltage of the external input power·P1)+P2, P1 is a first time parameter within 0.98 and 0.99 ns/V, and P2 is a second time parameter within 31.1 and 31.9 ns.
